(19) United States
(12) Patent Application Publication
(10) Pub. No.: US 2024/0213711 A1
(43) Pub. Date: Jun. 27, 2024

(54) ELECTRICAL CONNECTOR

(71) Applicant: Apple Inc., Cupertino, CA (US)

(72) Inventors: Stephen E. Yao, San Mateo, CA (US); James C. Wu, Redwood City, CA (US); Christopher S. Graham, San Francisco, CA (US)

(21) Appl. No.: 18/598,590

(22) Filed: Mar. 7, 2024

Related U.S. Application Data
(63) Continuation of application No. PCT/US22/76471, filed on Sep. 15, 2022.
(60) Provisional application No. 63/261,253, filed on Sep. 15, 2021.

(51) Int. Cl. H01R 13/62; H01R 13/627; H01R 13/639

(52) U.S. Cl. CPC H01R 13/6205; H01R 13/6275; H01R 13/639

(57) ABSTRACT

An electronic device can include a housing forming an aperture within an exterior surface of the housing. An electronic component can be disposed within the housing and include a receptacle coupled to the electronic component. The housing and the receptacle can form an electrical port. The electronic device can further include a first engagement feature and a cable having a first plug connector and a second plug connector. The first plug connector can include a boot, a plug, and a second engagement feature. The boot is receivable within the aperture formed within the exterior surface of the housing. The plug is receivable within the receptacle to electrically couple the electronic device with the cable. The second engagement feature can interconnect or otherwise engage the first engagement feature to retain the cable to the electronic device.

### CROSS-REFERENCE TO RELATED APPLICATION(S)

This application is a continuation of International Application No. PCT/US2022/076471, filed 15 Sep. 2022, and entitled “ELECTRICAL CONNECTOR,” which claims priority to U.S. Provisional Patent Application No. 63/261,253, filed 15 Sep. 2021, and entitled “ELECTRICAL CONNECTOR,” the disclosures of which are hereby incorporated by reference in their entireties.

### FIELD

The described examples relate generally to cables and wires of electronic devices. More particularly, the present examples relate to interconnects between a cable or wire and electronic devices.

### BACKGROUND

Electronic devices are increasingly being designed with device portability in mind, for example, to allow users to use these devices in a wide variety of situations and environments. Indeed, power sources, such as lithium batteries, can power an electronic device for a substantial duration of time and in a variety of indoor and outdoor environments. Components within an electronic device, such as, a processor, memory, antennas, and other components, can be disposed within a portable housing to protect the components from damage or failure induced by an environment external to the housing. Improvements and advances to portable electronic devices can be desirable to provide additional functionality in a variety of situations and environments.

### SUMMARY

According to some aspects of the present disclosure, an electrical port can include a trim ring, a receptacle, and an engagement feature. The trim ring can include an internal wall at least partially defining a cavity. The trim ring can be configured to substantially surround a boot of a plug connector. The receptacle can be coupled to the trim ring. The receptacle can be configured to receive a plug of the plug connector. The engagement feature can be disposed within either the cavity or the adjacent the receptacle. The engagement feature can be configured to interlock with the plug connector. The engagement feature can further include an elongate member disposed within the receptacle, the elongate member defining a distal end configured to interlock with the plug connector.

In some examples, the trim ring can be configured to surround the boot of the plug connector such that the boot is substantially flush with an external surface of the trim ring when the distal end of the elongate member is interlocked with the plug connector. In some examples, the trim ring can define a first aperture. The receptacle can define a second aperture. The electrical port can further include a fastener at least partially disposed within the first aperture and the second aperture to couple the receptacle to the trim ring. In some examples, the elongate member can be a protrusion formed on the internal wall of the trim ring. In some examples, the engagement feature can be an elongate member disposed within the receptacle. The elongate member can extend through the internal wall to interlock with the plug connector.

In some examples, the engagement feature can further include a magnet disposed within the trim ring or the receptacle. In some examples, the engagement feature can be a recess formed within the receptacle and configured to receive at least a portion of a canted coil spring. In some examples, the internal wall is configured to frictionally engage with the boot. In examples, the receptacle can be configured to electrically couple to a power source. In some examples, the canted coil spring can exert a force on the elongate member. In some examples, the electrical port can include a seal.

According to some examples, a plug connector for a cable can include a boot, a plug extending from the boot, and an engagement recess defined by an exterior surface of the boot. The engagement recess can be configured to interlock with an electrical port of an electronic device.

In some examples, the engagement recess can further include a canted coil spring at least partially disposed within a channel defined on an exterior surface of the boot. In some examples, the engagement recess can include a first recess defined on a first side of the boot, and a second recess defined on a second opposite side of the boot. In some examples, the engagement feature can be a channel defined by an exterior surface of the boot. The channel can extend around a periphery of the boot. In some examples, the engagement feature can be a magnet disposed within the boot. In some examples, the engagement feature can include a first engagement feature, and further including a second engagement feature defined by the plug.

According to some aspects, a cable assembly for an electronic device can include a cable, a plug connector attached to the cable, the plug connector including a boot, a plug extending from the boot and electrically connected to the cable, and an engagement feature defined in the plug. The engagement feature can include a groove defined by the plug, and a canted coil spring disposed in the groove.

In some examples, the plug can include a first surface and a second surface substantially parallel to the first surface. The plug can include an electrical contact. The canted coil spring can encircle a periphery of the plug. The engagement feature can include a recess defined by the plug, and a canted coil spring can be disposed in the recess. In some examples, the engagement feature can be a first engagement feature on a first side of the plug, and the plug can also include a second engagement feature on a second side of the plug opposite the first side. The electrical contact can be a first electrical contact and the plug can also include a second electrical contact. The recess can be defined by the plug and can extend around a periphery of the plug.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a perspective view of an electronic device.

FIG. 1B shows a perspective view of the electronic device of FIG. 1A and a cable.

FIG. 2A shows a perspective view of a cable inserted into an electronic device.

FIG. 2B shows a partially exploded view of the cable, a trim ring, and a receptacle.

FIG. 3A shows a detail view of a cable and a receptacle.

FIG. 3B shows a detail view of a biasing element of the receptacle and a plug of the cable.

FIG. 3C shows a detail view of the biasing element disposed within a recess of the plug.

FIG. 3D shows detail view of a set of biasing elements of the receptacle and the plug of the cable.

FIG. 4A shows a perspective view of a cable.

FIG. 4B shows a cross-sectional side view of the cable inserted into a trim ring and receptacle of an electronic device.

FIG. 5A shows a perspective view of a cable.

FIG. 5B shows a cross-sectional side view of the cable inserted into a trim ring and a receptacle of an electronic device.

FIG. 6A shows a perspective view of a cable.

FIG. 6B shows a cross-sectional top view of the cable inserted into a trim ring and a receptacle of an electronic device.

FIG. 7A shows a perspective view of a cable.

FIG. 7B shows a side view of the cable.

FIG. 7C shows a cross-sectional side view of the cable inserted into a trim ring and a receptacle of an electronic device.

FIG. 8 shows a cross-sectional top view of a cable inserted into a trim ring and a receptacle of an electronic device.

FIG. 9A shows a perspective view of a cable.

FIG. 9B shows a cross-sectional side view of the cable inserted into a trim ring and receptacle of an electronic device.

FIG. 10A shows a cross-sectional top view of a cable prior to insertion into a receptacle of an electronic device.

FIG. 10B shows a cross-sectional top view of the cable after insertion into the receptacle of the electronic device.

FIG. 11 shows a cross-sectional top view of a cable within a trim ring and a receptacle of an electronic device.

FIG. 12 shows a cross-sectional top view of a cable within a trim ring and a receptacle of an electronic device.

FIG. 13A shows a cross-sectional top view of a cable prior to complete insertion into a trim ring and a receptacle of an electronic device.

FIG. 13B shows a cross-sectional top view of a cable after complete insertion into a trim ring and a receptacle of an electronic device.

FIG. 14 shows a cross-sectional top view of a cable within a housing, a trim ring, and a receptacle of an electronic device.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, combinations, modifications, and equivalents as can be included within the spirit and scope of the described examples as defined by the appended claims.

Portable electronic devices, such as smart phones, laptops, tablet computing devices, smart watches, head-mounted displays (HMD), and headphones, have become commonplace for persons undertaking daily activities (travel, communication, education, entertainment, employment, etc.). Indeed, portable electronic devices can provide assistance in completing daily tasks and errands, such as, watching an instructional video or monitoring progress during and after an exercise routine. However, some electronic devices necessarily require a temporary or permanent cabled connection to operate (e.g., charging the device, providing electrical power to an electronic component, interconnecting a peripheral input or output device, etc.). Examples of electronic devices that may require a temporary or permanent cabled connection to operate are disclosed in Provisional Patent Application No. 63/261,254, filed 15 Sep. 2021, and entitled “Electrical Connector” and Provisional Patent Application No. 63/261,257, filed 15 Sep. 2021, and entitled “Electrical Connector,” the disclosures of which are incorporated herein in their entireties, by reference. As such, a cabled connection that does not unwantedly or accidentally disconnect can be desirable. For example, a connection that requires more force to remove the connection than establish the connection (i.e., disconnecting a cable from a port versus inserting a connector into the port).

One aspect of the present disclosure relates to an electronic device including a housing that defines an exterior surface of the electronic device. The housing can form an aperture within the exterior surface. An electronic component can be disposed within the housing and include a receptacle coupled to the electronic component. The housing and the receptacle can form an electrical port. The electronic device can further include a first engagement feature and a cable having a first plug connector and a second plug connector. The first plug connector can include a boot, a plug, and a second engagement feature. The boot is receivable within the aperture formed within the exterior surface of the housing. The plug is receivable within the receptacle to electrically couple the electronic device with the cable. The second engagement feature can interconnect or otherwise engage the first engagement feature to retain the cable to the electronic device.

In examples, the first and second engagement features can be one or more: biasing elements, latches, arms, protrusions, recesses, channels, magnets, canted coiled springs, rotating members, sliding members, another type of engagement feature, or a combination thereof. In some examples, at least the boot or plug and the aperture or receptacle can include one or more engagement features that interlock or interconnect the cable to the electronic device. In some examples, the first engagement feature and the second engagement feature can require a lesser force to connect the cable to the electronic device (e.g., insert the plug into the receptacle) and a greater force to disconnect the cable from the electronic device (e.g., remove the plug from the receptacle). In other words, a force required to withdraw the plug from the receptacle can be sufficiently large to prevent or limit unwanted or accidental removal of the cable from the electronic device.

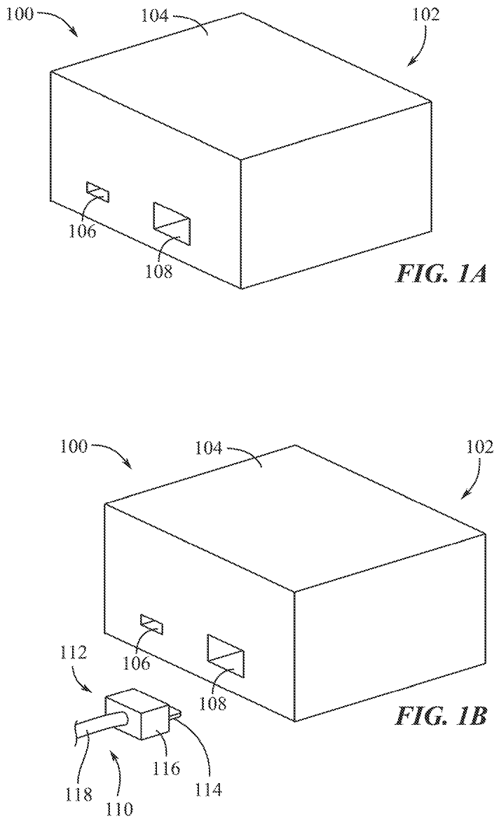

These and other examples are discussed below with reference to FIGS. 1A-14. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A shows an electronic device 100 having a housing 102 forming an external surface 104 of the electronic device 100. The housing 102 can form or define one or more apertures 106, 108. Each of the one or more apertures 106, 108 can receive a connector of an electrical cord or cable (see cable 110 of FIG. 1B) to electrically couple the electronic device 100 to another electronic device (not shown) and/or a power source (e.g., a wall-mounted electrical outlet).

The electronic device 100 can be a smart phone, a laptop, a tablet computing device, a smart watch, a head-mounted display (HMD), a pair of headphones, a combination thereof, or any other electronic device. Alternatively, or additionally, the electronic device 100 can be a sub-component or an accessory to one or more of the electronic devices previously listed above, such as, an external power supply or electrical power source, a display, a user interface, an audio component or speaker, or a combination thereof. As such, the electronic device 100 can be electrically and/or communicatively coupled to one or more other electronic devices (not shown) via electrical receptacles or ports disposed within the one or more apertures 106, 108.

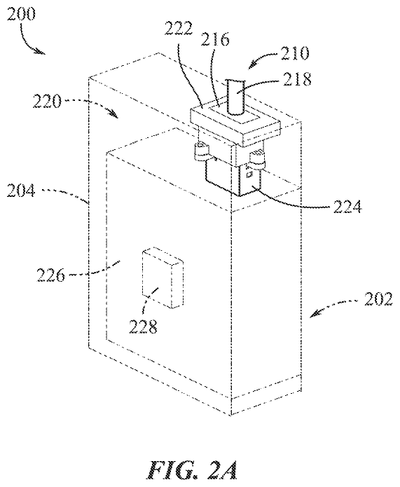

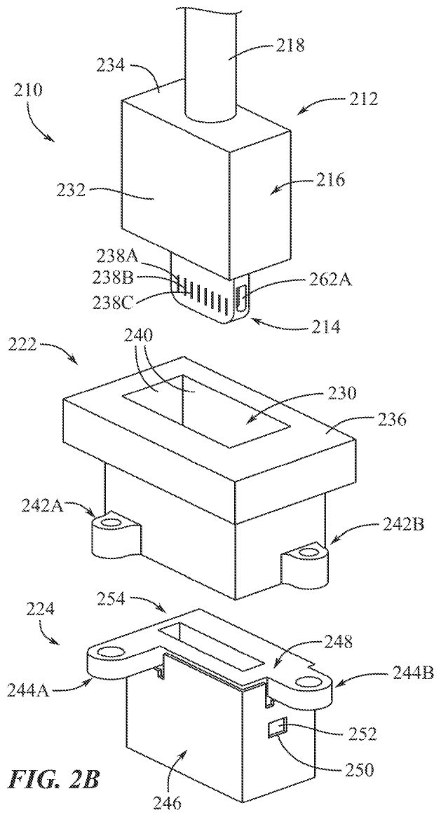

The housing 102 can define a cavity or volume wherein one or more electronic components can be disposed. For example, the one or more electrical components disposed within the housing 102 can be a battery (e.g., lithium battery pack), a processor, a wireless communication module, one or more antennas, or any other component or assembly housed within portable electronic devices. In examples, the one or more electronic components can be electrically coupled to a receptacle (see receptacle 224 in FIG. 2A) accessible by a cable or cord inserted into one of the apertures 106, 108. For example, the one or more electronic components can provide electrical power to the receptacle and the cable or cord can transfer the electrical power to another electronic device (i.e., the electronic device 100 can be a power source or external battery electrically coupled to a portable electronic device). The housing 102 can be molded, machined, cast, stamped, or otherwise assembled from a metal, polymer, ceramic, or combination thereof.

The aperture 106 can be formed within or defined by the external surface 104 of the housing 102. The aperture 106 can be sized and shaped to receive and retain a plug connector of a cable (see cable 110 in FIG. 1B). In examples, a cable operably coupled to a receptacle within the aperture 106 can transfer electrical power to the electronic device 100 while the plug connector is disposed within the aperture 106. In other words, a receptacle within the aperture 106 can be configured to receive electrical power (e.g., from a wall-mounted electrical outlet) and deliver the electrical power to the one or more components within the housing 102 (e.g., charging a battery disposed within the housing 102).

The aperture 108 can be formed within or defined by the external surface 104 of the housing 102. The aperture 108 can be sized and shaped to receive a plug connector of a cable. In examples, a cable operably coupled to a receptacle within the aperture 108 can transfer electrical power from the electronic device 100 while the plug connector is disposed within the aperture 108. In other words, the receptacle within the aperture 108 can be configured to deliver or provide electrical power from the one or more components within the housing 102 to a portable electronic device electrically coupled to the cable.

While the apertures 106, 108 are shown as being positioned on a particular side of the housing 102, the apertures 106, 108 can be formed or otherwise positioned at any location on the external surface 104 of the housing 102. Similarly, while the apertures 106, 108 are shown as being disposed adjacent or substantially adjacent to one another, in some examples, the apertures 106, 108 can be formed or otherwise positioned at nonadjacent locations on the external surface 104 of the housing 102 (e.g., on opposite sides of the housing 102). While the apertures 106, 108 are depicted as having different dimensions (i.e., aperture 106 is shown as relatively smaller than aperture 108), the apertures 106, 108 can have the same dimensions or substantially similar dimensions in other examples. While two apertures (e.g., apertures 106, 108) are shown in FIGS. 1A and 1B, other examples can have more or fewer apertures. For example, the housing 102 can form a single aperture which is operable to provide electrical power and/or signals to a portable electronic device and also operable to receive electrical power and/or signals (e.g., from a portable electronic device and/or a wall-mounted electrical outlet).

FIG. 1B shows the electronic device 100 and a cable 110 receivable within one or more of the apertures 106, 108. The cable 110 can have a plug connector 112 having a plug 114 and a boot 116. The plug connector 112 can be electrically coupled to a length of shielded wire 118. The shielded wire 118 can be one or more wires (e.g., metallic wires capable of transferring electrical signals and/or electrical power). The one or more wires can be individually shielded or collectively shielded. The shielding can prevent each of the one or more wires from contacting one another. Additionally, or alternatively, the shielding can prevent or limit the influence of electromagnetic waves on each of the one or more wires. The plug connector 112 can be received within one of the apertures 106, 108 to electrically couple the cable 110 with the electronic device 100. For example, the plug 114 can be inserted within a receptacle (e.g., receptacle 224 of FIG. 2A) disposed within the housing 102 of the electronic device 100 to enable transfer of electrical power and/or signals relative to the electronic device 100. One or more of the plug 114, the boot 116, the apertures 104, 106, and the receptacle can include one or more engagement features that retain the plug connector 112 to the electronic device 100. The mechanisms and components capable of inter coupling the cable 110 and the electronic device 100 will be discussed in greater detail below with reference to FIGS. 2A-14.

FIG. 2A shows an electronic device 200 and a cable 210. The electronic device 200 can be substantially similar to, and can include some or all of, the features of the electronic device 100. For example, the electronic device 200 can include a housing 202 forming a cavity or volume 220. One or more electronic components can be disposed within the volume 220, for example, a trim ring 222 and a receptacle 224 operably coupled to a battery 226, a processor 228, a combination thereof, or any other electronic component. The trim ring 222 and the receptacle 224 can form an electrical port disposed within the volume 220. In some examples, an external surface 204 of the housing 202 can form an aperture 208 capable of receiving a plug connector 212 of the cable 210. The trim ring 222 can be positioned adjacent the aperture 208 such that a boot 216 of the plug connector 212 is disposed within the trim ring 222 while a plug is disposed within the receptacle 224. The trim ring and receptacle will be discussed in greater detail below with reference to FIG. 2B.

FIG. 2B shows a partially exploded view of the cable 210, the trim ring 222, and the receptacle 224. The cable 210 can be substantially similar to, and can include some or all of, the features of the cable 110. For example, the cable 210 can include the plug connector 212 having a plug 214 and a boot 216. The plug connector 212 can be electrically coupled to a length of shielded wire 218. In examples, the boot 216 can be sized or otherwise shaped to be at least partially receivable within a cavity 230 formed within the trim ring 222. For example, the cavity 230 can be shaped as cubic, cylindrical, triangular, or any other geometric shape and the boot 216 can form a corresponding geometric shape which can be inserted or otherwise positioned within the cavity 230. In examples, the boot 216 can be partially disposed within the cavity 230 such that a portion of the boot 216 protrudes from the cavity 230. Alternatively, the boot 216 can be entirely surrounded or substantially surrounded by the trim ring 222 and within the cavity 230, such that a wire-side surface 234 of the boot 216 adjacent the shielded wire 218 is flush or substantially flush with a surface 236 of the trim ring 222 adjacent the cavity 230. In examples, the surface 232 of the boot 216 can be disposed within the cavity 230 of the trim ring 222 such that the wire-side surface 234 is flush or substantially flush with the external surface 204 of the housing 202 such that the boot 216 is substantially concealed or hidden within the cavity 230 of the trim ring 222. In some examples, while the boot 216 is disposed within the cavity 230, the boot 216 can be substantially covered by the trim ring 222 such that the boot 216 cannot be gripped (e.g., by a user) and pulled from the trim ring 216. In other words, a substantial portion of the boot 216 can be disposed within the cavity 230 such that the boot 216 may not be accessible to grasp to pull the plug connector 212 from the trim ring 222 and receptacle 224. The plug 214 can include one or more electrical contacts 238A, 238B, 238C providing electrical signals, electrical power, a grounding path, another electrical communication, or a combination thereof between the shielded wire 218 and the receptacle 224.

The trim ring 222 can be molded, machined, cast, stamped, or otherwise manufactured from a metal, polymer, ceramic, or combination thereof. For example, the trim ring 222 can be molded or co-molded from a thermoplastic or other polymer. The cavity 230 formed within the trim ring 222 can be at least partially defined by internal walls 240. In examples, the boot 216 can contact one or more of the internal walls 240 while the boot 216 is positioned within the cavity 230 such that the boot 216 is at least partially retained within the cavity 230 by a frictional engagement between the boot 216 and the internal walls 240. In examples, the trim ring 222 can be adhered, molded, welded, fastened, or otherwise affixed to the receptacle 224. For example, the trim ring 222 can define one or more trim ring apertures 242A, 242B which correspond to and align with respective receptacle apertures 244A, 244B of the receptacle 224. A respective fastener (not shown) can be disposed within the receptacle aperture 244A and the trim ring aperture 242A to couple the trim ring 222 to the receptacle 224. Similarly, a respective fastener (not shown) can be disposed within the receptacle aperture 244B and the trim ring aperture 242B to couple the trim ring 222 to the receptacle 224. The fastener can be a pin, rivet, screw, bolt, a combination thereof, or any other fastener.

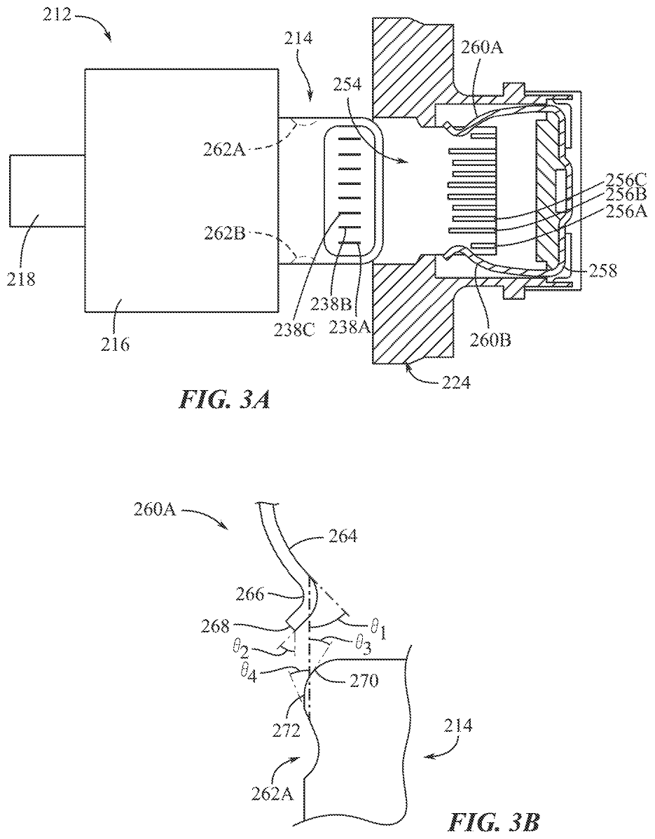

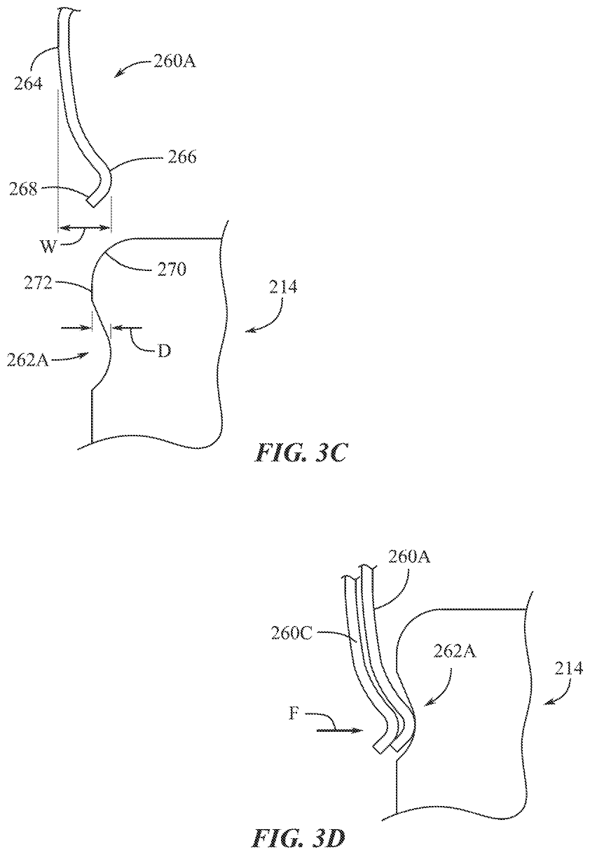

In some examples, the receptacle 224 can include an exterior portion 246 and an interior portion 248. For example, the exterior portion 246 can at least partially encompass the interior portion 248. In other words, the exterior portion 246 can act as a sleeve or shell that at least partially surrounds the interior portion 248. The exterior portion 246 and interior portion 248 can be interlocked or affixed to one another. For example, the exterior portion 246 can include a through-hole 250 that receives a protrusion 252 of the interior portion 246 when the interior portion 248 is affixed within the exterior portion 246. In some examples, the receptacle 224 can be formed from a singular or monolithic structure instead of the external and internal portions 246, 248. The receptacle 224 can form a slot 254 capable of receiving and retaining the plug 214. The receptacle 224 and plug 214 will be discussed in greater detail below with reference to FIGS. 3A-3D.

FIG. 3A shows the plug connector 212 and a partial sectional view of the receptacle 224. In examples, one or more internal contacts 256A, 256B, 256C can be disposed within the slot 254 such that the contacts 238A, 238B, 238C of the plug 214 touch or otherwise engage the internal contacts 256A, 256B, 256C positioned within the slot 254. In some examples, the internal contacts 256A, 256B, 256C disposed within the slot 254 can be one or more metal prongs biased to engage the contacts 238A, 238B, 238C while the plug 214 is disposed within the slot 254. The internal contacts 256A, 256B, 256C can be electrically connected to a printed circuit board (PCB), a processor, one or more wires, a combination thereof, or another component positioned within the housing (e.g., housing 102, 202).

In examples, the receptacle 224 can include a biasing element 258 having one or more latches or arms 260A, 260B. Each of the arms 260A, 260B can form an end of the biasing element 258 such that the arms 260A, 260B make up a singular or monolithic structure (i.e., the biasing element 258). While the plug 214 is disposed within the slot 254, each of the arms 260A, 260B can be biased into a recess (e.g., recesses 262A, 262B shown in FIGS. 2B and 3B) defined by the plug 214. The arms 260A, 260B and the recesses 262A, 262B will be described in greater detail below with reference to FIGS. 3B-3D.

FIG. 3B shows a detail view of the recess 262A of the plug 214 and the arm 260A. In examples, the arm 260A can include a linear portion 264, a curved portion 266, and a distal end 268. The linear portion 264 and the curved portion 266 can form a first angle θ₁. The first angle θ₁ can be less than 90 degrees, such as, between about 89 degrees and about 60 degrees, between about 60 degrees and about 30 degrees, between about 30 degrees and about 5 degrees, or greater than about 5 degrees. In examples, a force required to withdraw the plug 214 from the slot 254 can correlate to the first angle θ₁. For Example, a relatively smaller first angle θ₁ (e.g., between about 5 degrees and 45 degrees) can cause the force required to remove the plug 214 from the slot 254 to be relatively smaller. Alternatively, a relatively larger first angle θ₁ (e.g., between about 45 degrees and 89 degrees) can cause the force required to remove the plug 214 from the slot 254 to be relatively larger. In other words, a size of the first angle θ₁ can be chosen to generate a desired force required to extract the plug 214 from the receptacle 224 (i.e., extract the arm 260A from the recess 262A).

Similarly, the curved portion 266 and the distal end 268 can form a second angle θ₂. The second angle θ₂ can be less than 90 degrees, such as, between about 89 degrees and about 60 degrees, between about 60 degrees and about 30 degrees, between about 30 degrees and about 5 degrees, or greater than about 5 degrees. In examples, a force required to insert the plug 214 into the slot 254 can correlate to the second angle θ₂. For Example, a relatively smaller second angle θ₂ (e.g., between about 5 degrees and 45 degrees) can cause the force required to insert the plug 214 into the slot 254 to be relatively smaller. Alternatively, a relatively larger second angle θ₂ (e.g., between about 45 degrees and 89 degrees) can cause the force required to insert the plug 214 into the slot 254 to be relatively larger. In other words, a size of the second angle θ₂ can be chosen to generate a desired force required to insert the plug 214 into the receptacle 224 (i.e., insert the arm 260A into the recess 262A).

In examples, the plug 214 can include a curved portion 270, a linear portion 272, and the recess 262A. The curved portion 270 and the linear portion 272 can form a third angle θ₃. The third angle θ₃ can be less than 90 degrees, such as, between about 89 degrees and about 60 degrees, between about 60 degrees and about 30 degrees, between about 30 degrees and about 5 degrees, or greater than about 5 degrees. In examples, a force required to insert the plug 214 into the slot 254 can correlate to the third angle θ₃. For Example, a relatively smaller third angle θ₃ (e.g., between about 5 degrees and 45 degrees) can cause the force required to insert the plug 214 into the slot 254 to be relatively smaller. Alternatively, a relatively larger third angle θ₃ (e.g., between about 45 degrees and 89 degrees) can cause the force required to insert the plug 214 into the slot 254 to be relatively larger. In other words, a size of the third angle θ₃ can be chosen to generate a desired force required to insert the plug 214 into the receptacle 224 (i.e., insert the arm 260A passed the curved portion 270).

Similarly, the linear portion 272 and the recess 262A can form a fourth angle θ₄. The fourth angle θ₄ can be less than 90 degrees, such as, between about 89 degrees and about 60 degrees, between about 60 degrees and about 30 degrees, between about 30 degrees and about 5 degrees, or greater than about 5 degrees. In examples, a force required to withdraw the plug 214 from the slot 254 can correlate to the fourth angle θ₄. For Example, a relatively smaller fourth angle θ₄ (e.g., between about 5 degrees and 45 degrees) can cause the force required to remove the plug 214 from the slot 254 to be relatively smaller. Alternatively, a relatively larger fourth angle θ₄ (e.g., between about 45 degrees and 89 degrees) can cause the force required to remove the plug 214 from the slot 254 to be relatively larger. In other words, a size of the fourth angle θ₄ can be chosen to generate a desired force required to extract the plug 214 from the receptacle 224 (i.e., extract the arm 260A from the recess 262A).

Additionally, or alternatively, as shown in FIG. 3C, a width W defined by the arm 260A and a depth D of the recess 260 can correlate to the force required to insert the plug 214 into the slot 254 or extract the plug 214 from the slot 254. The width W can be defined as an offset or distance between the linear portion 264 and the curved portion 266.

In some examples, one or more additional arms 260C can be paired with the arm 260A to increase the force required to insert the plug 214 into the slot 254 or extract the plug 214 from the slot 254. For example, as shown in FIG. 3D, the arm 260C can be overlaid or otherwise disposed adjacent to the arm 260A such that a force F applied on the plug 214 by the combination of arms 260A, 260C is increased, thereby increasing the force required to insert the plug 214 into the slot 254 or extract the plug 214 from the slot 254.

While the description of FIGS. 3B-3D primarily relates to arm 260A, the aspects of these examples can alternatively, or additionally, be applied to arm 260B shown in FIG. 3A. That is, in some examples, the plug 214 can have two or more recesses which respectively engage with the arm 260A and the arm 260B. Similarly, while the description of FIGS. 3B-3D primarily relates to recess 262A of the plug 214, the aspects of these examples can alternatively, or additionally, be applied to recess 262B shown in FIG. 3A.

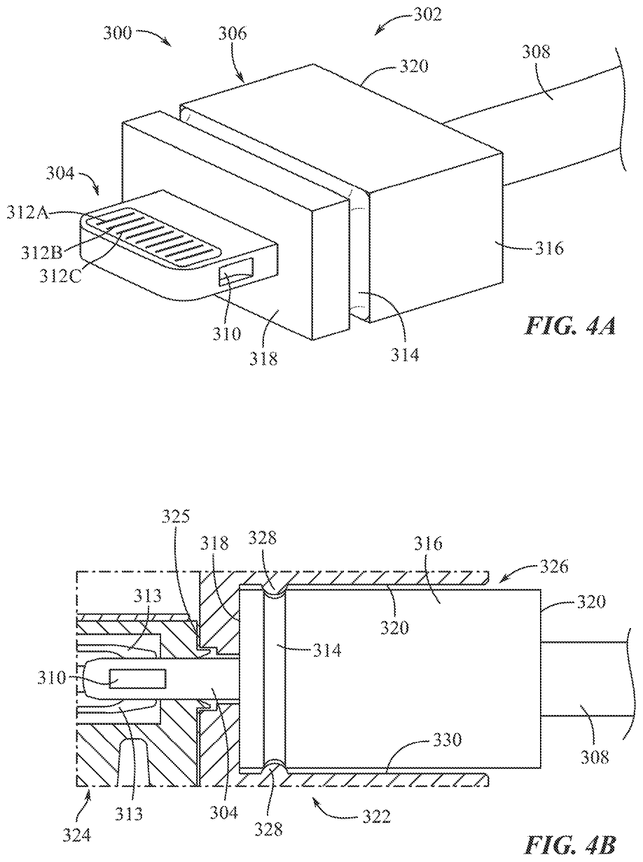

Any number or variety of components in any of the configurations described herein can be included in the electronic device. The components can include any combination of the features described herein and can be arranged in any of the various configurations described herein. The structure and arrangement of components of an electronic device having a housing with structures described herein, and defining an internal volume, as well as the concepts regarding various engagement features, can apply not only to the specific examples discussed herein, but to any number of examples in any combination. Examples of engagement features of an electronic device and/or a cable are described below, with reference to FIGS. 4A-4B.

FIG. 4A shows a portion of a cable 300 having a plug connector 302. The cable 300 can also include a second plug connector (not shown). The second plug connector can have similar features as the plug connector 302 in some examples. In other examples, the second plug connector can be distinct from the plug connector 302. The cable 300 can be substantially similar to, and can include some or all of, the features of the cables 110, 210. For example, the plug connector 302 can include a plug 304, a boot 306, and a shielded wire 308. The plug 304 can include one or more electrical contacts 312A, 312B, 312C providing electrical communication between the shielded wire 308 and a receptacle (see receptacle 324 of FIG. 4B). Accordingly, the receptacle 324 can include one or more internal contacts 313 interfacing the one or more electrical contacts 312A, 312B, 312C of the plug 304 to provide electrical communication between the shielded wire 308 and a receptacle.

The example plug connector 302 illustrated in FIG. 4A can include a recess 310 formed on the plug 304. In some examples, a biasing element (e.g., biasing element 258) having one or more latches or arms (e.g., latches or arms 260A, 260B) can engage or interface the recess 310 to retain the plug 304 within a slot (e.g., slot 254) of the receptacle. In other examples, however, the plug 304 may not include the recess 310.

In examples, the boot 306 defines or otherwise forms a channel 314. The channel 314 can be machined, molded, etched, or otherwise recessed into an exterior surface 316 of the boot 306. In some examples, the channel 314 can extend along a periphery of the boot 206 and between a plug-side surface 318 of the boot 306 and a wire-side surface 320 of the boot 306. In examples, the channel 314 can extend parallel to and between the plug-side surface 318 and the wire-side surface 320. The channel 314 can extend around an entire periphery or substantially the entire periphery of the boot 306. Alternatively, the channel 314 can extend along only a portion of the periphery of the boot 306. For example, the channel 314 can extend along one or more sides of the boot 306 (e.g., the sides of the boot 306 that make up the external surface 316).

FIG. 4B shows the plug connector 302 positioned (i.e., inserted) into a trim ring 322 and a receptacle 324. The trim ring 322 can be substantially similar to, and can include some or all of, the features of the trim ring 222. For example, the trim ring 322 can define an aperture or cavity 326 sized and shaped to house at least a portion of the boot 306. A protrusion 328 of the trim ring 322 can extend into the cavity 326 and be received within the channel 314 while the boot 306 is at least partially disposed within the cavity 326 of the trim ring 322. In other words, the protrusion 328 can extend from an interior sidewall 330, which defines the cavity 326, to contact the exterior surface 316 and/or the channel 314 of the boot 306. The interface or engagement between the protrusion 328, the exterior surface 316, and/or the channel 314 can increase a force required to extract the boot 306 from the trim ring 322. Additionally, or alternatively, the interface or engagement between the protrusion 328, the exterior surface 316, and/or the channel 314 can act as a seal which prevents or limits ingress of contaminants (e.g., liquid, dust, lint, debris, etc.) into the receptacle 324 through the cavity 326 of the trim ring 322. Additionally, or alternatively, a seal 325 can be positioned between the trim ring 322 and the receptacle 324 to prevent or limit ingress of contaminants (e.g., liquid, dust, lint, debris, etc.) into the receptacle 324 or the electronic device (e.g., electronic device 100) through the cavity 326 of the trim ring 322.

In some examples, more than one channel 314 can be formed on the exterior surface 316 of the boot 306. For example, a first channel can be formed adjacent or substantially adjacent the wire-side surface 320 and a second channel can be formed adjacent or substantially adjacent the plug-side surface 318. The relative positions and dimensions (e.g., width, depth, radius, etc.) of the first and second channels can correlate to a position and a dimension of respective protrusions formed on one or more interior side walls (see side walls 240) of the trim ring 322. While FIGS. 4A and 4B show the boot 306 as forming the channel 314 and the trim ring 322 as forming the protrusion 328, the boot 306 can alternatively, or additionally, form the protrusion 328 and the trim ring 322 can alternatively, or additionally, form the channel 314. Any number and combinations of channels and protrusions can be formed by boot 306 and the trim ring 322.

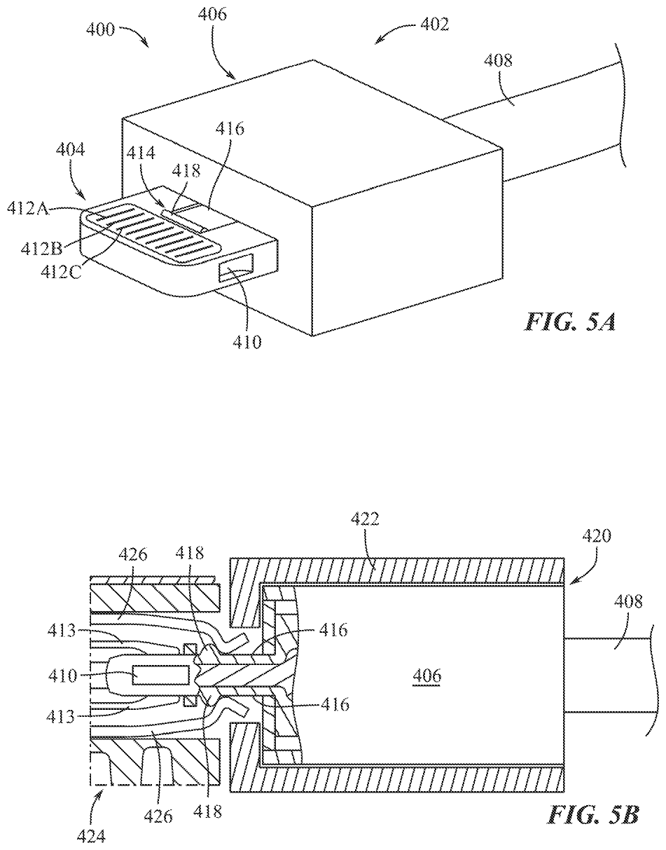

Any number or variety of components in any of the configurations described herein can be included in the electronic device. The components can include any combination of the features described herein and can be arranged in any of the various configurations described herein. The structure and arrangement of components of an electronic device having a housing with structures described herein, and defining an internal volume, as well as the concepts regarding various engagement features, can apply not only to the specific examples discussed herein, but to any number of examples in any combination. Examples of engagement features of an electronic device and/or a cable are described below, with reference to FIGS. 5A-5B.

FIG. 5A shows a portion of a cable 400 including a plug connector 402. The cable 400 can also include a second plug connector (not shown). The second plug connector can have similar features as the plug connector 402 in some examples. In other examples, the second plug connector can be distinct from the plug connector 402. The cable 400 can be substantially similar to, and can include some or all of, the features of the cables 110, 210. For example, the plug connector 402 can include a plug 404, a boot 406, and a shielded wire 408. The plug 404 can include one or more electrical contacts 412A, 412B, 412C providing electrical communication between the shielded wire 408 and a receptacle (see receptacle 424 of FIG. 5B). Accordingly, the receptacle can include one or more internal contacts 413 interfacing the one or more electrical contacts 412A, 412B, 412C of the plug 404 to provide electrical communication between the shielded wire 408 and a receptacle. The example plug connector 402 illustrated in FIG. 5A includes a recess 410 formed on the plug 404 and configured to engage a biasing element (e.g., biasing element 258). However, in other examples, the plug 404 may not include the recess 410.

In examples, the plug 404 can include one or more engagement features 414 formed on one or more surfaces of the plug 404. For example, the engagement features 414 can be formed on the same surfaces as the one or more electrical contacts 412A, 412B, 412C. The one or more engagement features 414 can include a recessed portion 416 and a protruding portion 418. The one or more engagement features 414 will be described in further detail herein, for example, with reference to FIG. 5B.

FIG. 5B shows the plug connector 402 positioned (i.e., inserted) into a trim ring 422 and a receptacle 424. The trim ring 422 can be substantially similar to, and can include some or all of, the features of the trim ring 222. For example, the trim ring 422 can define an aperture or cavity 420 sized and shaped to house at least a portion of the boot 406. The receptacle 424 can include one or more elongate members 426 that engage, interlock, or otherwise interface with the respective engagement features 414. For example, the elongate members 426 can be curved, bent, or hooked at a distal end to engage, interlock, or otherwise interface at least one of the recessed portion 416 or the protruding portion 418. The recessed portion 416 can enlarge an engagement surface of the protruding portion 418 (i.e., a surface contacted by the curved, bent, or hooked section of the elongate member 426) while minimizing a distance the protruding portion 418 extends from the plug 404. In other words, the recessed portion 416 maximizes an engagement surface of the protruding portion 418 while minimizing a thickness of the plug 404.

In some examples, one or more angles formed by the protruding portion 418 and/or the curved, bent, or hooked distal end of the elongate member 426 can correlate to a force required to extract the plug 404 from the receptacle 424 or insert the plug 404 into the receptacle 424. Accordingly, the description relating to the angles (e.g., angles θ₁, θ₂, θ₃, θ₄) shown within FIG. 3B is equally applicable to the elongate members 426 and engagement features 414 shown in FIG. 5B. For example, a force required to withdraw the plug 404 from the receptacle 424 can correlate to the one or more angles formed by the elongate member(s) 426 and/or the protruding portion 418.

Additionally, or alternatively, similar to the description herein referencing FIG. 3C, a width defined by the elongate member 426 and a depth of the recessed portion 416 can correlate to the force required to insert the plug 404 into the receptacle 424 or extract the plug 404 from the receptacle 424. The width can be defined as an offset or distance between a linear portion of the elongate member 426 and the curved, bent, or hooked portion of the elongate member 426.

While the receptacle 424 illustrated in FIG. 5B includes respective elongate members 426 contacting opposing sides of the plug 404, other examples can include additional or fewer engagement features 414 and/or elongate members 426. For example, the receptacle 424 can include a lone or singular elongate member 426 which extends to engage a lone or singular engagement feature 414 formed on the plug 404.

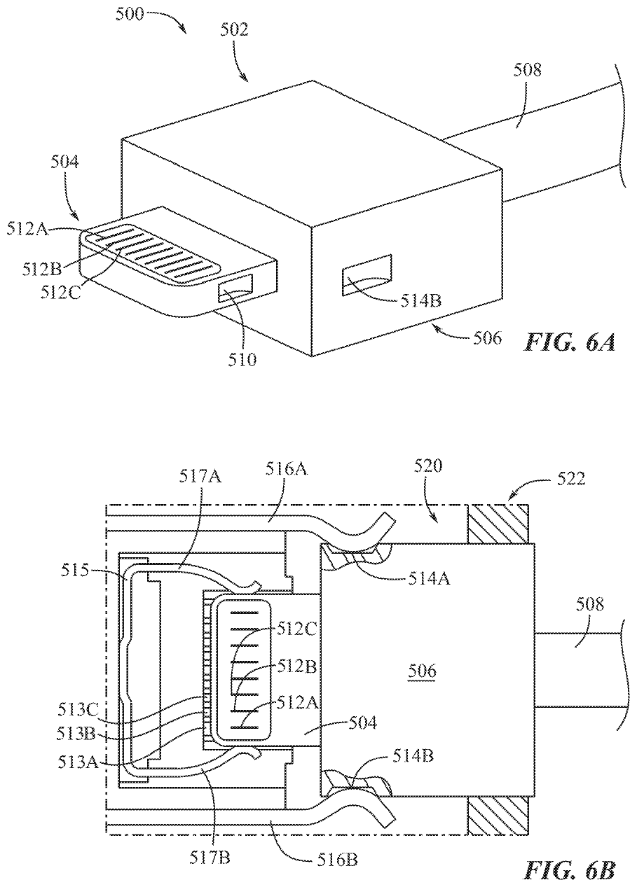

Any number or variety of components in any of the configurations described herein can be included in the electronic device. The components can include any combination of the features described herein and can be arranged in any of the various configurations described herein. The structure and arrangement of components of an electronic device having a housing with structures described herein, and defining an internal volume, as well as the concepts regarding various engagement features, can apply not only to the specific examples discussed herein, but to any number of examples in any combination. Examples of engagement features of an electronic device and/or a cable are described below, with reference to FIGS. 6A-6B.

FIG. 6A shows a portion of a cable 500 having a plug connector 502. The cable 500 can also include a second plug connector (not shown). The second plug connector can have similar features as the plug connector 502 in some examples. In other examples, the second plug connector can be distinct from the plug connector 502. The cable 500 can be substantially similar to, and can include some or all of, the features of the cables 110, 210. For example, the plug connector 502 can include a plug 504, a boot 506, and a shielded wire 508. The plug 504 can include one or more electrical contacts 512A, 512B, 512C providing electrical communication between the shielded wire 508 and a receptacle (see receptacle 524 of FIG. 4B). Accordingly, the receptacle can include one or more internal contacts 513A, 513B, 513C interfacing the one or more electrical contacts 512A, 512B, 512C of the plug 504 to provide electrical communication between the shielded wire 508 and a receptacle.

The example plug connector 502 illustrated in FIG. 6A can include a recess 510 formed on the plug 504. In some examples, a biasing element (see biasing element 515 of FIG. 6B) having one or more latches or arms (see latches or arms 517A, 517B of FIG. 6B) can engage or interface the recesses 510 to retain the plug 504 within a slot (e.g., slot 254) of the receptacle 524. The biasing element 515 and arms 517A, 517B can be substantially similar to, and can include some or all of, the features of the biasing element 258 and arms 260A, 260B. Additionally, or alternatively, the receptacle 524 can include one or more latches or arms (see latches or arms 516A, 516B of FIG. 6B) can engage or interface boot recesses 514A, 514B to couple the plug connector 502 to the receptacle 524. The arms 516A, 516B will be described in greater detail herein, for example, with reference to FIG. 6B.

FIG. 6B shows the plug connector 502 positioned (i.e., inserted) into a housing 522 and a receptacle 524 positioned within the housing 522. The housing 522 can be substantially similar to, and can include some or all of, the features of the housing 102. For example, the housing 522 can define an aperture or cavity 520 sized and shaped to house at least a portion of the boot 506. In other examples, a trim ring (e.g., trim ring 422) can be disposed within the housing 522 and receive at least a portion of the boot 506. The receptacle 524 can include one or arms 516A, 516B that engage, interlock, or otherwise interface with the respective boot recesses 514A, 514B. For example, each of the arms 516A, 516B can be curved, bent, or hooked at a distal end to engage, interlock, or otherwise interface at least one of the boot recesses 514A, 514B.

In some examples, one or more angles formed by the curved, bent, or hooked distal end of the arm 516A and/or arm 516B can correlate to a force required to extract or detach the boot 506 from the receptacle 524 or insert the plug 504 into the receptacle 524. Accordingly, the description relating to the angles (e.g., angles θ₁, θ₂, θ₃, θ₄) shown within FIG. 3B is equally applicable to the arms 516A, 516B and boot recesses 514A, 514B shown in FIG. 6B. For example, a force required to withdraw the plug 504 from the receptacle 524 can correlate to one or more angles formed by the distal ends of the arms 516A, 516B and/or the recesses 514A, 514B.

Additionally, or alternatively, similar to the description herein referencing FIG. 3C, a width defined by a respective arm 516A or arm 516B and a depth of the correlating boot recess 514A, 514B can affect the force required to insert the plug 504 into the receptacle 524 or extract the plug 504 from the receptacle 524. The width can be defined as an offset or distance between a linear portion of the respective arm 516A or 516B and the curved, bent, or hooked portion of the respective arm 516A or 516B.

While the receptacle 524 illustrated in FIG. 6B includes respective arms 516A, 516B contacting opposing sides of the boot 506, other examples can include additional or fewer arms. For example, the receptacle 524 can include a lone or singular arm 516 which extends to engage a lone or singular boot recess 514 formed on the boot 506.

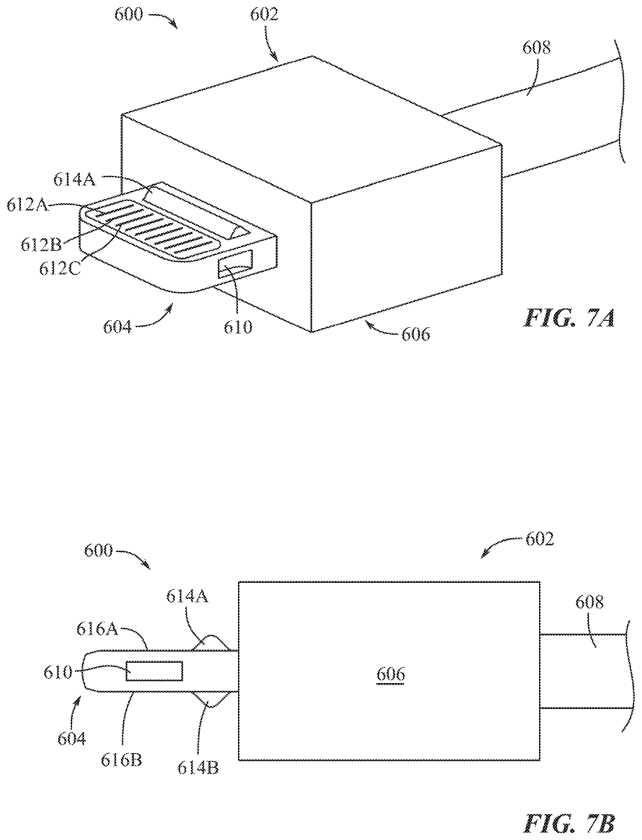

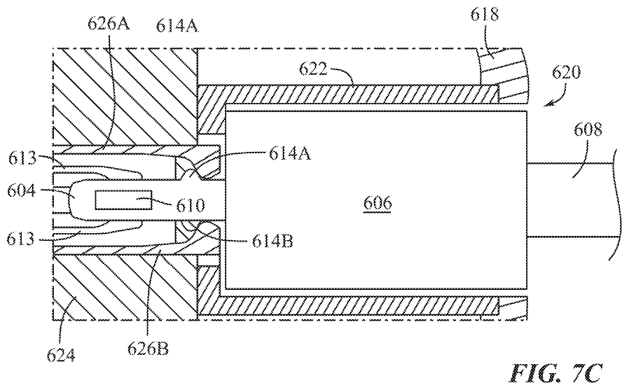

Any number or variety of components in any of the configurations described herein can be included in the electronic device. The components can include any combination of the features described herein and can be arranged in any of the various configurations described herein. The structure and arrangement of components of an electronic device having a housing with structures described herein, and defining an internal volume, as well as the concepts regarding various engagement features, can apply not only to the specific examples discussed herein, but to any number of examples in any combination. Examples of engagement features of an electronic device and/or a cable are described below, with reference to FIGS. 7A-7B.

FIGS. 7A and 7B show a portion of a cable 600 including a plug connector 602. The cable 600 can also include a second plug connector (not shown). The second plug connector can have similar features as the plug connector 602 in some examples. In other examples, the second plug connector can be distinct from the plug connector 602. The cable 600 can be substantially similar to, and can include some or all of, the features of the cables 110, 210. For example, the plug connector 602 can include a plug 604, a boot 606, and a shielded wire 608. The plug 604 can include one or more electrical contacts 612A, 612B, 612C providing electrical communication between the shielded wire 608 and a receptacle (see receptacle 624 of FIG. 7C). Accordingly, the receptacle can include one or more internal contacts 613 interfacing the one or more electrical contacts 612A, 612B, 612C of the plug 604 to provide electrical communication between the shielded wire 608 and a receptacle. The example plug connector 602 illustrated in FIG. 6A includes a recess 610 formed on the plug 604 and configured to engage a biasing element (e.g., biasing element 258). However, in other examples, the plug 604 may not include the recess 610.

In examples, the plug 604 can include one or more protrusions 614 formed on one or more surfaces of the plug 604. For example, a first protrusion 614A can be formed on a first surface 616A of the plug 604 and a second protrusion 614B can be formed on a second surface 616B of the plug 604. In other examples, a single protrusion (e.g., either protrusion 614A or protrusion 614B) can be formed on the plug 604. Each of the one or more protrusions 614 can be machined, molded, adhered, fastened, welded, or otherwise affixed to the plug 604. The one or more protrusions 614 will be described in further detail herein, for example, with reference to FIG. 7C.

FIG. 7C shows the plug connector 602 positioned (i.e., inserted) into a housing 618, a trim ring 622, and a receptacle 624. The trim ring 622 can be disposed within the housing 618 and coupled to the housing 618. In other examples, the housing 618 and trim ring 622 can be monolithically formed to define a singular or unitary structure. The trim ring 622 can be substantially similar to, and can include some or all of, the features of the trim ring 222. For example, the trim ring 622 can define an aperture or cavity 620 sized and shaped to house at least a portion of the boot 606.

The receptacle 624 can include one or more elongate members 626A, 626B that engage, interlock, or otherwise interface with the respective protrusions 614A, 614B. For example, the elongate members 626A, 626B can be curved, bent, or hooked at a distal end to engage, interlock, or otherwise interface with the protrusions 614A, 614B. In some examples, one or more angles formed by the protrusions 614A, 614B and/or the curved, bent, or hooked distal end of the elongate member 626A, 626B can correlate to a force required to extract the plug 604 from the receptacle 624 or insert the plug 604 into the receptacle 624. Accordingly, the description relating to the angles (e.g., angles θ₁, θ₂, θ₃, θ₄) shown within FIG. 3B is equally applicable to the elongate members 626A, 626B and protrusions 614A, 614B shown in FIG. 7C. For example, a force required to withdraw the plug 604 from the receptacle 624 can correlate to the one or more angles formed by the elongate member(s) 626 and/or the protrusion(s) 614.

While the receptacle 624 illustrated in FIG. 7B includes respective elongate members 626A, 626B contacting opposing sides 616A, 616B of the plug 604, other examples can include additional or fewer elongate members 626. For example, the receptacle 624 can include a lone or singular elongate member 626 which extends to engage a lone or singular protrusion 614 formed on the plug 604.

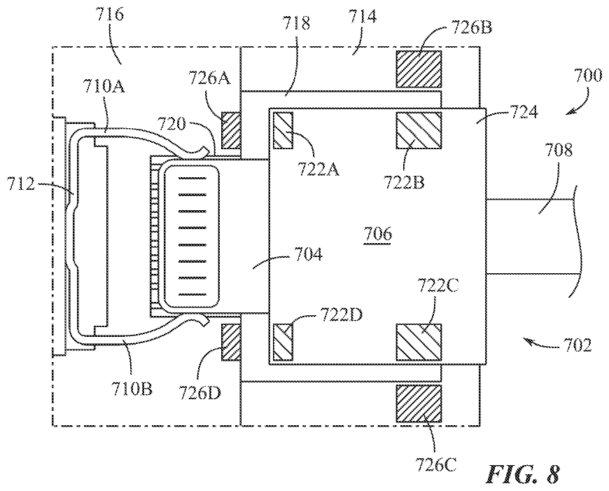

Any number or variety of components in any of the configurations described herein can be included in the electronic device. The components can include any combination of the features described herein and can be arranged in any of the various configurations described herein. The structure and arrangement of components of an electronic device having a housing with structures described herein, and defining an internal volume, as well as the concepts regarding various engagement features, can apply not only to the specific examples discussed herein, but to any number of examples in any combination. Examples of engagement features of an electronic device and/or a cable are described below, with reference to FIG. 8.

FIG. 8 shows a partial cross-sectional top view of a cable 700. The cable 700 includes a plug connector 702 having a plug 704, a boot 706, and a shielded wire 708. The plug 704 can be substantially similar to, and can include some or all of, the features of the plug 214. For example, the plug 704 can define one or more recesses (e.g., recesses 262A, 262B) that engage or otherwise interface with latches or arms 710A, 710B of a biasing element 712. The boot 706 can be disposed within a trim ring 714 and the plug can be disposed within a receptacle 716. For example, the trim ring 714 can define an aperture or cavity 718 sized and shaped to house at least a portion of the boot 706 and the receptacle 716 can form a slot 720 sized and shaped to receive at least a portion of the plug 704.

In examples, the boot 706 can include one or more boot magnets (e.g., boot magnets 722A, 722B, 722C, 722D). The one or more boot magnets 722A, 722B, 722C, 722D can be positioned within the boot 706 or otherwise affixed to an external surface 724 of the boot 706. The trim ring 714 and/or the receptacle 716 can include one or more magnets 726A, 726B, 726C, 726D. For example, magnets 726A, 726D can be disposed within the receptacle 716 while magnets 726B, 726C are disposed within the boot 706. Each of the one or more boot magnets 722A, 722B, 722C, 722D can generate a magnetic force which assists to maintain or retain the plug connector 702 within the trim ring 714 and the receptacle 716. For example, the boot magnet 724A and the magnet 726A within the receptacle 716 can generate magnetic forces which attracts or draws the boot 706 to the receptacle 716. Similarly, the boot magnet 724D and the magnet 726D within the receptacle 716 can generate magnetic forces which attracts or draws the boot 706 to the receptacle 716. In examples, the boot magnet 722B and the magnet 726B within the trim ring 714 can generate magnetic forces which retain the boot 706 within the trim ring 714. Similarly, the boot magnet 722C and the magnet 726C within the trim ring 714 can generate magnetic forces which retain the boot 706 within the trim ring 714.

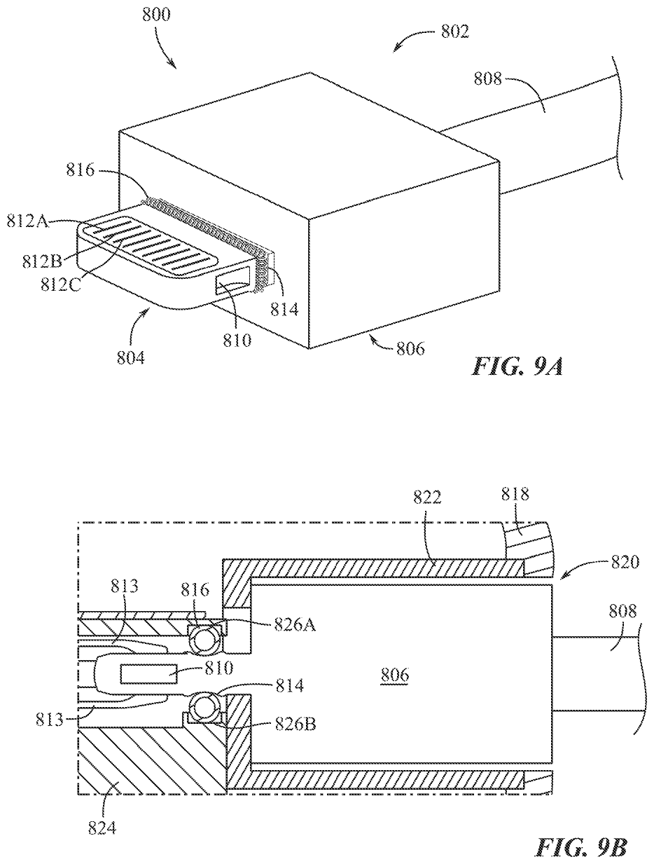

Any number or variety of components in any of the configurations described herein can be included in the electronic device. The components can include any combination of the features described herein and can be arranged in any of the various configurations described herein. The structure and arrangement of components of an electronic device having a housing with structures described herein, and defining an internal volume, as well as the concepts regarding various engagement features, can apply not only to the specific examples discussed herein, but to any number of examples in any combination. Examples of engagement features of an electronic device and/or a cable are described below, with reference to FIGS. 9A-9B.

FIG. 9A shows a portion of a cable 800 including a plug connector 802. The cable 800 can also include a second plug connector (not shown). The second plug connector can have similar features as the plug connector 802 in some examples. In other examples, the second plug connector can be distinct from the plug connector 802. The cable 800 can be substantially similar to, and can include some or all of, the features of the cables 110, 210. For example, the plug connector 802 can include a plug 804, a boot 806, and a shielded wire 808. The plug 804 can include one or more electrical contacts 812A, 812B, 812C providing electrical communication between the shielded wire 808 and a receptacle (see receptacle 824 of FIG. 9B). Accordingly, the receptacle can include one or more internal contacts 813 interfacing the one or more electrical contacts 812A, 812B, 812C of the plug 804 to provide electrical communication between the shielded wire 808 and a receptacle. The example plug connector 802 illustrated in FIG. 9A includes a recess 810 formed on the plug 804 and configured to engage a biasing element (e.g., biasing element 258). However, in other examples, the plug 804 may not include the recess 810.

In examples, the plug 804 can include a channel 814 and an engagement feature retained within the channel 814. For example, the engagement feature can be a canted coil spring 816. The canted coil spring 816 can be deformed or otherwise compressed to enable insertion of the plug 804 into the receptacle 824 and thereafter rebound or decompress to engage the receptacle 824 to prevent or inhibit extraction of the plug 804 from the receptacle 824. The canted coil spring 816 will be described in further detail herein, for example, with reference to FIG. 9B.

FIG. 9B shows the plug connector 802 positioned (i.e., inserted) into a housing 818, a trim ring 822, and a receptacle 824. The trim ring 822 can be formed as a singular monolithic structure within the housing 818 or as a distinct element that is adhered, welded, fastened, or otherwise affixed to the housing 818. The trim ring 822 can be substantially similar to, and can include some or all of, the features of the trim ring 222. For example, the trim ring 822 can define an aperture or cavity 820 sized and shaped to house at least a portion of the boot 806. The receptacle 824 can form one or more recesses 826A, 826B that engage, interlock, or otherwise interface with the canted coil spring 816. For example, the one or more recesses 826A, 826B can be sized and shaped such that the canted coil spring 816 can transition into the recesses 826A, 82B while in a compressed or deformed state, yet cannot be withdrawn from the recesses 826A, 826B after the canted coil spring 816 has rebounded or decompressed. Accordingly, the canted coil spring 816 can engage, interlock, or otherwise interface with at least one of the recesses 826A, 826B to impede or prevent removal of the plug 804 from the receptacle 824. While FIGS. 9A and 9B show the canted coil spring 816 disposed on the plug 804 prior to insertion, in some examples, the canted coil spring can be disposed within the receptacle 824 or trim ring 822 prior to insertion of the plug 804 and engage with a channel or recess formed on the plug 804 or the boot 806.

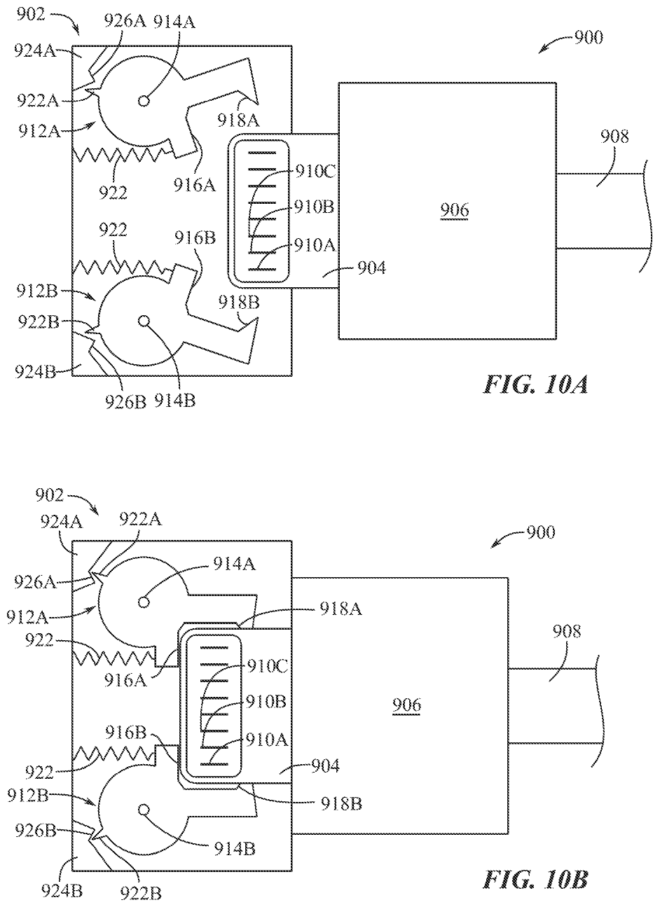

Any number or variety of components in any of the configurations described herein can be included in the electronic device. The components can include any combination of the features described herein and can be arranged in any of the various configurations described herein. The structure and arrangement of components of an electronic device having a housing with structures described herein, and defining an internal volume, as well as the concepts regarding various engagement features, can apply not only to the specific examples discussed herein, but to any number of examples in any combination. Examples of engagement features of an electronic device and/or a cable are described below, with reference to FIGS. 10A-10B.

FIG. 10A shows a cable 900 and a partial section view of a receptacle 902. The cable 900 can be substantially similar to, and can include some or all of, the features of the cables 110, 210. For example, the cable 900 can include a plug 904, a boot 906, and a shielded wire 908. The plug 904 can include one or more electrical contacts 910A, 910B, 910C providing electrical communication between the shielded wire 908 and the receptacle 902. Accordingly, the receptacle 902 can include one or more internal contacts (not shown) interfacing the one or more electrical contacts 910A, 910B, 910C of the plug 904 to provide electrical communication between the shielded wire 908 and a receptacle 902. The plug 904 can be at least partially insertable into the receptacle 902.

During insertion of the plug 904 into the receptacle 902, one or more rotating members 912A, 912B of the receptacle 902 can be rotated about a respective axis of rotation 914A, 914B to interlock or retain the plug 904 to the receptacle 902. For example, each of the one or more rotating members 912A, 912B can form a surface 916A, 916B that contacts the plug 904 when the plug 904 is inserted into the receptacle 902. The plug 904 can engage the surfaces 916A, 916B to cause each of the rotating members 912A, 912B to rotate about their respective axis of rotation 914A, 914B. The rotation can cause respective interlocking features 918A, 918B of formed on each rotating member 912A, 912B to rotate into contact with the plug 904 and thereby retain the plug 904 to the receptacle 902. For example, the interlocking features 918A, 918B can rotate into respective recesses (not shown, see recesses 262A, 262B shown in FIGS. 2B and 3B) to retain the plug 904 to the receptacle 902. In some examples, one or more of the rotating members 912A, 912B can be biased to rotate about the axis of rotation 914A, 914B by a spring 920 or other biasing element. For example, the spring 920 can bias the rotating member 912A, 912B to rotate out-of-contact with the plug 904 to provide an obstructed path for insertion of the plug 904 into the receptacle 902.

As shown in FIG. 10B, each of the one or more rotating members 912A, 912B can include a protrusion 922A, 922B which rotates to interface with an interlock 924A, 924B disposed within the receptacle 902. For example, rotation of the rotating member 912A can cause the protrusion 922A to transition over a surface 926A of the interlock 924A. The surface 926A of the interlock 924A can prevent or inhibit the protrusion 922A from transitioning back out of engagement with the interlock 924A. Similarly, rotation of the rotating member 912B can cause the protrusion 922B to transition over a surface 926B of the interlock 924B. The surface 926B of the interlock 924B can prevent or inhibit the protrusion 922B from transitioning back out of engagement with the interlock 924B. In some examples, at least one of the protrusions 922A, 926B and/or the surfaces 926A, 926B can be deformable or otherwise sufficiently pliant to enable the one of the protrusions 922A, 922B to transition past their respective surfaces 926A, 926B.

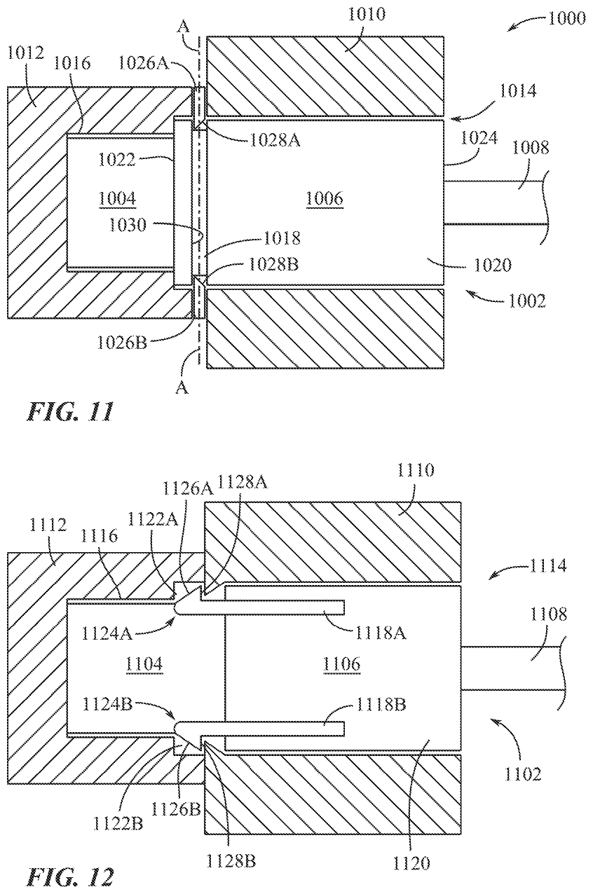

Any number or variety of components in any of the configurations described herein can be included in the electronic device. The components can include any combination of the features described herein and can be arranged in any of the various configurations described herein. The structure and arrangement of components of an electronic device having a housing with structures described herein, and defining an internal volume, as well as the concepts regarding various engagement features, can apply not only to the specific examples discussed herein, but to any number of examples in any combination. Examples of engagement features of an electronic device and/or a cable are described below, with reference to FIG. 11.

FIG. 11 shows a partial cross-sectional top view of a cable 1000. The cable 1000 includes a plug connector 1002 having a plug 1004, a boot 1006, and a shielded wire 1008. The plug 1004 can be substantially similar to, and can include some or all of, the features of the plug 214. The boot 1006 can be disposed within a trim ring 1010 and the plug 1004 can be disposed within a receptacle 1012. For example, the trim ring 1010 can define an aperture or cavity 1014 sized and shaped to house at least a portion of the boot 1006 and the receptacle 1012 can form a slot 1016 sized and shaped to receive at least a portion of the plug 1004. In some examples, the trim ring 1010 can be coupled to a housing (e.g., the housing 202) of an electronic device (e.g., the electronic device 200). For example, the trim ring 1010 can be monolithically formed from the housing or otherwise affixed or adhered the housing.

In examples, the boot 1006 defines or otherwise forms a channel 1018. The channel 1018 can be machined, molded, etched, or otherwise recessed into an exterior surface 1020 of the boot 1006. In some examples, the channel 1018 can extend along a periphery of the boot 1006 and between a plug-side surface 1022 of the boot 1006 and a wire-side surface 1024 of the boot 1006. In examples, the channel 1018 can extend parallel to and between the plug-side surface 1022 and the wire-side surface 1024. The channel 1018 can extend around an entire periphery or substantially the entire periphery of the boot 1006. Alternatively, the channel 1018 can extend along only a portion of the periphery of the boot 1006. For example, the channel 1018 can extend along one or more sides of the boot 1006 (e.g., the sides of the boot 1006 that make up the external surface 1020).

In examples, one or more engagement features 1026A, 1026B can translate into the channel 1018 after the boot 1006 has been disposed within the cavity 1014 of the trim ring 1010. The one or more engagement features 1026A, 1026B can translate along an axis A that extends parallel to or substantially parallel to a length of the channel 1018. In some examples, each of the one or more engagement features 1026A, 1026B can be biased to translate into the channel 1018. For example, each of the engagement features 1026A, 1026B can include a respective angled section 1028A, 1028B which contacts the boot 1006 as the plug 1004 is inserted into the receptacle 1012. The contact between the boot 1006 and the respective angled sections 1028A, 1028B can force each respective engagement feature 1026A, 1026B translate away from the boot 1006 along the axis A. Once the respective angled sections 1028A, 1028B of each engagement feature 1026A, 1026B reach the channel 1018, the respective angled section 1028A, 1028B can be biased to translate into the channel 1018 (i.e., toward the boot 1006) along the axis A.

In some examples, at least a portion of each engagement feature 1026A, 1026B can contact a side wall 1030 of the channel 1018 to inhibit or prevent extraction of the boot 1006 from the trim ring 1010. For example, the portion of each engagement feature 1026A, 1026B that contacts the side wall 1030 can be parallel to the side wall 1030. Conversely, the respective angled sections 1028A, 1028B can extend non-parallel to the plug-side surface 1022 of the boot 1006, such that a force required to insert the plug 1004 into the receptacle 1012 is less than a force required to withdraw or extract the plug 1004 from the receptacle 1012.

Any number or variety of components in any of the configurations described herein can be included in the electronic device. The components can include any combination of the features described herein and can be arranged in any of the various configurations described herein. The structure and arrangement of components of an electronic device having a housing with structures described herein, and defining an internal volume, as well as the concepts regarding various engagement features, can apply not only to the specific examples discussed herein, but to any number of examples in any combination. Examples of engagement features of an electronic device and/or a cable are described below, with reference to FIG. 12.

FIG. 12 shows a partial cross-sectional top view of a cable 1100. The cable 1100 includes a plug connector 1102 having a plug 1104, a boot 1106, and a shielded wire 1108. The plug 1104 can be substantially similar to, and can include some or all of, the features of the plug 214. The boot 1106 can be disposed within a trim ring 1110 and the plug 1104 can be disposed within a receptacle 1112. For example, the trim ring 1110 can define an aperture or cavity 1114 sized and shaped to house at least a portion of the boot 1106 and the receptacle 1112 can form a slot 1116 sized and shaped to receive at least a portion of the plug 1104. In some examples, the trim ring 1110 can be coupled to a housing (e.g., the housing 202) of an electronic device (e.g., the electronic device 200). For example, the trim ring 1110 can be monolithically formed from the housing or otherwise affixed or adhered the housing.

In examples, one or more engagement features 1118A, 1118B can be coupled, molded, fastened, or otherwise affixed to the boot 1106. The one or more engagement features 1118A, 1118B can be disposed within the boot 1106 or affixed to an external surface 1120 of the boot 1106. The one or more engagement features 1118A, 1118B can extend into the slot 1116 and interlock with the trim ring 1110 and/or the receptacle 1112 to inhibit or prevent removal of the boot 1106 from the trim ring 1110. For example, the trim ring 1110 and/or the boot 1106 can form a respective niche 1122A, 1122B that engages with a distal end 1124A, 1124B of the one or more engagement features 1118A, 1118B to inhibit or prevent removal of the boot 1106 from the trim ring 1110. The distal end 1124A of the engagement feature 1118A can include an angled surface 1126A and a planar surface 1128A. While the distal end 1124A of the engagement feature 1118A is being positioned within the niche 1122A (i.e., while the boot 1106 is being inserted into the trim ring 1110), the angled surface 1126A can more easily enable the distal end 1124A to pass into the slot 1116. Once the distal end 1124A is disposed within the niche 1122A (i.e., once the boot 1106 is fully inserted into the trim ring 1110), the planar surface 1128A can prevent or inhibit removal of the engagement feature 1118A from the niche 1122A.

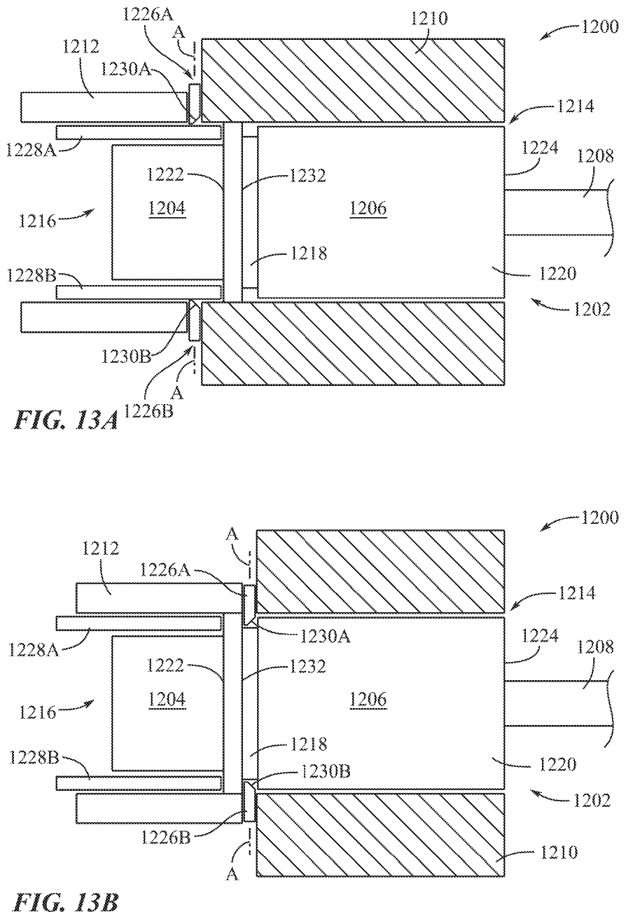

Any number or variety of components in any of the configurations described herein can be included in the electronic device. The components can include any combination of the features described herein and can be arranged in any of the various configurations described herein. The structure and arrangement of components of an electronic device having a housing with structures described herein, and defining an internal volume, as well as the concepts regarding various engagement features, can apply not only to the specific examples discussed herein, but to any number of examples in any combination. Examples of engagement features of an electronic device and/or a cable are described below, with reference to FIGS. 13A-13B.

FIG. 13A shows a partial cross-sectional top view of a cable 1200. The cable 1200 includes a plug connector 1202 having a plug 1204, a boot 1206, and a shielded wire 1208. The plug 1204 can be substantially similar to, and can include some or all of, the features of the plug 214. The boot 1206 can be disposed within a trim ring 1210 and the plug 1204 can be disposed within a receptacle 1212. For example, the trim ring 1210 can define an aperture or cavity 1214 sized and shaped to house at least a portion of the boot 1206 and the receptacle 1212 can form a slot 1216 sized and shaped to receive at least a portion of the plug 1204. In some examples, the trim ring 1210 can be coupled to a housing (e.g., the housing 202) of an electronic device (e.g., the electronic device 200). For example, the trim ring 1210 can be monolithically formed from the housing or otherwise affixed or adhered the housing.

In examples, the boot 1206 defines or otherwise forms a channel 1218. The channel 1218 can be machined, molded, etched, or otherwise recessed into an exterior surface 1220 of the boot 1206. In some examples, the channel 1218 can extend along a periphery of the boot 1206 and between a plug-side surface 1222 of the boot 1206 and a wire-side surface 1224 of the boot 1206. In examples, the channel 1218 can extend parallel to and between the plug-side surface 1222 and the wire-side surface 1224. The channel 1218 can extend around an entire periphery or substantially the entire periphery of the boot 1206. Alternatively, the channel 1218 can extend along only a portion of the periphery of the boot 1206. For example, the channel 1218 can extend along one or more sides of the boot 1206 (e.g., the sides of the boot 1206 that make up the external surface 1220).

In examples, one or more engagement features 1226A, 1226B can translate into the channel 1218 after the boot 1206 contacts one or more blocks 1228A, 1228B and moves the one or more blocks 1228A, 1228B out of contact with the one or more engagement features 1226A, 1226B. For example, the plug-side surface 1222 can drive the blocks 1228A, 1228B out of contact with the engagement features 1226A, 1226B when the boot 1206 is at least partially inserted into the trim ring 1210. The blocks 1228A, 1228B can be disposed within the receptacle 1212 and prevent the engagement features 1226A, 1226B from transitioning toward each other along axis A before the channel 1218 is aligned with axis A. As shown in FIG. 13B, the boot 1206 can drive the blocks 1228A, 1228B deeper into the cavity slot 1216 of the receptacle to enable the engagement features 1226A, 1226B to transition into the channel 1218.

Each of the engagement features 1226A, 1226B can include a respective angled section 1230A, 1230B which can ease transitioning the engagement feature 1226A, 1226B from contacting the one of the blocks 1228A, 1228B to contacting the boot 1206. Once the respective angled sections 1230A, 1230B of each engagement feature 1226A, 1226B reach the channel 1218, the respective angled section 1230A, 1230B can be biased to translate into the channel 1218 (i.e., toward the boot 1206) along the axis A.

In some examples, at least a portion of each engagement feature 1226A, 1226B can contact a side wall 1232 of the channel 1218 to inhibit or prevent extraction of the boot 1206 from the trim ring 1210. For example, the portion of each engagement feature 1226A, 1226B that contacts the side wall 1232 can be parallel to the side wall 1232. Conversely, the respective angled sections 1230A, 1230B can extend non-parallel to the plug-side surface 1222 of the boot 1206, such that a force required to insert the plug 1204 into the receptacle 1212 is less than a force required to withdraw or extract the plug 1204 from the receptacle 1212.

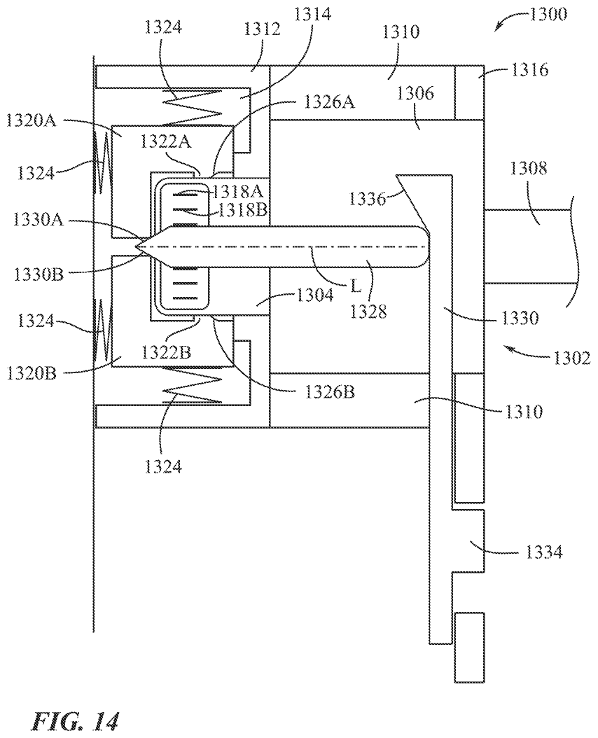

Any number or variety of components in any of the configurations described herein can be included in the electronic device. The components can include any combination of the features described herein and can be arranged in any of the various configurations described herein. The structure and arrangement of components of an electronic device having a housing with structures described herein, and defining an internal volume, as well as the concepts regarding various engagement features, can apply not only to the specific examples discussed herein, but to any number of examples in any combination. Examples of engagement features of an electronic device and/or a cable are described below, with reference to FIGS. 14.

FIG. 14 shows cable 1300 having a plug connector 1302 including a plug 1304, a boot 1306, and a shielded wire 1308. The plug 1304 can be substantially similar to, and can include some or all of, the features of the plug 214. The boot 1306 can be disposed within a trim ring 1310 and the plug 1304 can be disposed within a receptacle 1312. For example, the trim ring 1310 can define an aperture or cavity sized and shaped to house at least a portion of the boot 1306 and the receptacle 1312 can form a slot 1314 sized and shaped to receive at least a portion of the plug 1304. In some examples, the trim ring 1310 can be coupled to a housing 1316 of an electronic device (e.g., the electronic device 200). For example, the trim ring 1310 can be monolithically formed from the housing 1316 or otherwise affixed or adhered the housing 1316. As shown in FIG. 14, in some examples, the boot 1306 can be flush with the housing 1316 (i.e., an external-facing surface of the boot 1306 can be flush with an external-facing surface of the housing 1316) when the plug connector 1302 is disposed within the trim ring 1310 and the receptacle 1312.

In examples, the plug 1304 can include one or more electrical contacts 1318A, 1318B providing electrical communication between the shielded wire 1308 and the receptacle 1312. Accordingly, the receptacle 1312 can include one or more internal contacts (not shown, see internal contacts 613 of FIG. 7C) interfacing the one or more electrical contacts 1318A, 1318B of the plug 604 to provide electrical communication between the shielded wire 608 and a receptacle. For example, the electrical contacts 1318A, 1318B can be communicatively coupled to one or more electronic components disposed within the housing 1316 which provide electrical power to the cable 1300 through the electrical contacts 1318A, 1318B. The cable 1300 can transfer the electrical power to another electronic device.

The plug 1304 can be releasably retained within the receptacle 1312, such that the plug connector 1302 is retained within the housing 1316 and the boot 1306 is retained within the trim ring 1310. For example, the plug 1304 can form one or more recesses (e.g., recesses 262A, 262B shown in FIG. 3A). In examples, one or more engagement features 1320A, 1320B can be disposed within the receptacle 1312 and occupy a respective recess of the plug 1304 to retain the plug 1304 within the receptacle 1312. Each of the one or more engagement features 1320A, 1320B can include a protrusion 1322A, 1322B which at least partially occupies a respective recess to retain the plug 1304 within the receptacle 1312. Each of the protrusions 1322A, 1322B can transition with the engagement features 1320A, 1320B to enter and exit the respective recess.

In some examples, one or more of the engagement features 1320A, 1320B can be biased (e.g., by one or more springs 1324) to maintain contact with the plug 1304. Each of the protrusions 1322A, 1322B can include a respective angled section 1326A, 1326B which contacts the plug 1304 as the plug 1304 is inserted into the receptacle 1312. The contact between the plug 1304 and the respective angled sections 1326A, 1326B can force each respective engagement feature 1320A, 1320B translate away from the plug 1304. Once the respective angled sections 1326A, 1326B of each protrusion 1322A, 1322B reach the respective recesses, the respective angled section 1326A, 1326B can be biased to translate into the recesses (i.e., toward the plug 1304).

In examples, the one or more engagement features 1320A, 1320B can be driven apart or moved out of contact with the plug 1304 to release the plug 1304 from the receptacle 1312. For example, a dividing member 1328 can be at least partially disposed between the engagement features 1320A, 1320B. The dividing member 1328 can have angled surfaces 1330A, 1330B which are symmetrical about a longitudinal axis L of the dividing member 1328. When forced between the engagement features 1320A, 1320B, the dividing member 1328 can cause the engagement features 1320A, 1320B to move out of contact with the plug 1304 and thereby release the plug 1304 from the receptacle 1312. A direction the dividing member 1328 moves can be perpendicular to one or more directions the engagement features 1320A, 1320B moves.

In some examples, the dividing member 1328 moves when an actuating member 1330 moves in a direction perpendicular to the longitudinal axis L of the dividing member 1328. For example, a user can slide an interface portion 1334 of the actuating member 1330 relative to the housing 1316 and thereby cause a sloped surface 1336 of the actuating member 1330 to drive the dividing member 1328 between the engagement features 1320A, 1320B. In some examples, the dividing member 1328 can be biased (e.g., by the springs 1324 and each engagement feature 1320A, 1320B applying a force on the angled surfaces 1330A, 1330B of the dividing member 1328) to move back toward the housing 1316. The actuating member 1330 can move in one or more directions that are perpendicular to the longitudinal axis L of the dividing member 1328.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. An electrical port for receiving a plug connector including a boot, comprising:
a trim ring including an internal wall at least partially defining a cavity, the cavity configured to substantially surround the boot;
a receptacle coupled to the trim ring further defining the cavity; and
an engagement feature disposed within the cavity configured to interlock with the plug connector, the engagement feature comprising an elongate member disposed within the receptacle, the elongate member defining a distal end configured to interlock with the plug connector.

2. The electrical port of claim 1, wherein:
the trim ring further comprises an external surface;
the boot includes a top surface; and
the external surface is substantially parallel with the top surface when the distal end of the elongate member is interlocked with the plug connector.

3. The electrical port of claim 1, wherein:
the trim ring defines a first aperture;
the receptacle defines a second aperture; and
the electrical port further comprises a fastener at least partially disposed within the first aperture and the second aperture.

4. The electrical port of claim 1, wherein the elongate member comprises a protrusion formed on the internal wall of the trim ring.

5. The electrical port of claim 1, wherein the elongate member extends through the internal wall to interlock with the plug connector.

6. The electrical port of claim 1, wherein the engagement feature further comprises a magnet disposed within the cavity.

7. The electrical port of claim 1, wherein the engagement feature further comprises a canted coil spring.

8. The electrical port of claim 1, wherein the internal wall is sized to frictionally engage the boot.

9. The electrical port of claim 7, wherein the canted coil spring exerts a force on the elongate member.

10. The electrical port of claim 1, further comprising a seal positioned in the cavity.

11. A plug connector for a cable, comprising:
a boot;
a plug extending from the boot; and
an engagement recess defined by an exterior surface of the boot, the engagement recess configured to interlock with an electrical port of an electronic device.

12. The plug connector of claim 11, wherein the engagement recess further comprises a canted coil spring at least partially disposed within a channel defined on an exterior surface of the boot.

13. The plug connector of claim 11, wherein the engagement recess comprises a first recess defined on a first side of the boot and a second recess defined on a second opposite side of the boot.

14. The plug connector of claim 11, wherein the engagement recess comprises a channel extending around a periphery of the boot.

15. The plug connector of claim 11, wherein the engagement feature further comprises a magnet disposed within the boot.

16. The plug connector of claim 11, wherein the engagement feature comprises a first engagement feature, and further comprising a second engagement feature defined by the plug.

17. A cable assembly for an electronic device, comprising:
a cable;
a plug connector attached to the cable, the plug connector including a boot; and
a plug extending from the boot and electrically connected to the cable; and
an engagement feature defined in the plug, the engagement feature comprising:
a recess defined by the plug; and
a canted coil spring disposed in the recess.

18. The cable assembly of claim 17, wherein:
the plug comprises a first surface, and a second surface substantially parallel to the first surface;
the plug comprises an electrical contact;
the canted coil spring encircles a periphery of the plug.

19. The cable assembly of claim 18, wherein:
the engagement feature is a first engagement feature on a first side of the plug, and the plug connector further comprises a second engagement feature on a second side of the plug opposite the first side; and
the electrical contact is a first electrical contact and the plug further comprises a second electrical contact.

20. The cable assembly of claim 18, wherein the recess defined by the plug extends around a periphery of the plug.
